(19) United States
(12) Patent Application Publication
(10) Pub. No.: US 2011/0174237 A1
(43) Pub. Date: Jul. 21, 2011

(54) PET GARMENT WITH TREATMENT ELEMENT

(76) Inventors: Gail Sanders-Luckman, Chicago, IL (US); Jaclyn Fearheller, Chicago, IL (US)

(21) Appl. No.: 13/007,954

(22) Filed: Jan. 17, 2011

Related U.S. Application Data
(60) Provisional application No. 61/295,439, filed on Jan. 15, 2010.

(51) Int. Cl. A61D 7/00; A01K 27/00; A61D 9/00

(52) U.S. Cl. 119/792; 119/850; 119/860; 119/856

(57) ABSTRACT

A wrap device is configured for use as a pet garment having a receptacle for receiving a treatment element that can be used to provide warmth or cooling. The wrap device contains a leash-fastening assembly comprised of a ring attached to the outer side of the wrap. In one embodiment, an opening in the wrap receives said ring wherein the ring extends through the opening when the wrap is placed around a limb, torso or other body part of the pet. In another embodiment, the leash-fastening assembly may be comprised of a ring attached to a part of the wrap that is accessible after the wrap is placed on the pet.

### CROSS REFERENCE TO RELATED APPLICATIONS

This application claims the benefit of, and is a utility application of, co-pending prior U.S. Provisional Application No. 61/295,439, filed Jan. 15, 2010, which is expressly incorporated herein by reference and made a part hereof.

### STATEMENT REGARDING FEDERALLY-SPONSORED RESEARCH OR DEVELOPMENT

Not applicable.

### TECHNICAL FIELD

The invention relates to a pet garment or wrap device that accommodates a treatment element and more specifically, to a pet garment containing a receptacle for receiving a treatment element. The wrap may also contain a means for attaching a pet leash to the wrap avoiding the necessity of using a separate collar or harness.

### BACKGROUND

Most pets, when they are being walked or are outdoors, wear a collar or harness that attaches to a leash. Some pets also wear garments such as decorative garments or coats. Current pet garments do not provide further features for additional warming or cooling, or for providing additional therapies to pets while wearing the pet garment. In addition, current pet garments require the use of a separate collar or harness that attaches to a leash. While pet devices according to the prior art provide a number of advantageous features, they nevertheless have certain limitations. The present invention seeks to overcome certain of these limitations and other drawbacks of the prior art, and to provide new features not heretofore available.

### BRIEF SUMMARY

According to an aspect of the invention, the wrap device accommodates a portable treatment element, such as a thermal element, within the device to offer maximum comfort for the pet while it is in differing environments, mobile, outdoors, and/or for comfort, therapeutic or other treatment purposes. The device may be utilized without the treatment element and also has a means for attaching a leash thereby avoiding the need to use a separate collar or harness.

The wrap device provides comfort in differing types of weather and temperatures, and can be waterproof and washable. The treatment element may be a gel pack or some other device that can be heated, frozen or cooled so as to provide warmth or cooling once placed in the wrap. It may be kept in the freezer and may freeze flexibly, or it can be heated in the microwave or boiled in hot water. The treatment element may also be kept at room temperature. The treatment element may also contain vapor emitting compositions for the purpose of treatment or comfort to the wearer. The treatment element may be re-useable, non-toxic and water soluble.

In one embodiment, the wrap device has two openings through which the front paws of the pet are placed and the wrap comes up and around the wearer's body and connects on the back, or top, of the pet. The receptacle may be positioned to be adjacent to or in close proximity to the wearer's thoracic and abdomen areas as those areas are areas where body temperature can be affected. A treatment element, such as a thermal or vapor-emitting element may be placed into the receptacle.

The present invention provides a means of attaching a leash such that the use of a separate collar or harness is unnecessary. In one embodiment of the invention, there is a ring on the outer side of the garment and an opening that accommodates the ring. Once the garment is securely on and fastened on the top, or back of the pet, such that the section with the opening is overlapped on top of the outer side having the ring, the ring is inserted through the opening such that it protrudes from the opening, providing a ring for attachment to a leash connector and leash. The ring provides a point of attachment to the leash connector or leash and avoids the need for use of a collar or harness thereby providing ease of use and comfort for the pet.

In a second embodiment of the invention, the leash-fastening means is a ring-like structure that is located on a strap which lies on top of the wearer's back. The use of the term “ring” in any embodiment is not intended to suggest or require that the “ring” have a circular shape.

In other embodiments, the garment may be constructed to cover specific parts of the wearer. Such embodiments will possess a receptacle for receiving the treatment element and a fastening means to attach the wrap device to the pet. In these embodiments, the receptacle may be positioned such that it is adjacent to or in close proximity to other body parts of the wearer such as the hip, legs, neck etc.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a first embodiment of a pet garment according to the present invention, the pet garment shown being worn by a pet;

FIG. 2 is a bottom view of the pet garment shown in FIG. 1 with the collar shown in an extended position; and a receptacle located on a bottom side of the garment;

FIG. 3 is a top view of the pet garment shown in FIGS. 1 and 2 showing the receptacle on the inside of the garment and having a treatment element being partially inserted into the receptacle;

FIG. 4 is a bottom view of an alternative embodiment of the pet garment according to the present invention shown in FIG. 1 showing the receptacle located on the outer bottom side of the wrap;

FIG. 5 is a close-up view of part of the outer side of the pet garment shown in FIG. 1 and showing a leash-fastening assembly;

FIG. 6 is a perspective view of another embodiment of the pet garment according to the present invention showing use of a leash-fastening assembly;

FIG. 7 is a top view of the pet garment shown in FIG. 6;

FIG. 8 is bottom view of the pet garment shown in FIG. 6;

FIG. 9 is a top plan view of another embodiment of a pet garment and showing a treatment element being partially inserted into the receptacle;

FIG. 10 is a top plan view of another embodiment of a pet garment and showing a treatment element being partially inserted into the receptacle;

FIG. 11 is perspective view of another embodiment of the pet garment according to the present invention, the garment shown in an inverted assembled position;

FIG. 12 is a top view of the pet garment shown in FIG. 11; and

FIG. 13 is a bottom view of the pet garment shown in FIG. 11 and in the assembled position.

### DETAILED DESCRIPTION

While this invention is susceptible of embodiments in many different forms, exemplary embodiments of the invention are shown in the drawings and will herein be described in further detail with the understanding that the present disclosure is to be considered as an exemplification of the principles of the invention and is not intended to limit the broad aspect of the invention to the embodiments illustrated.

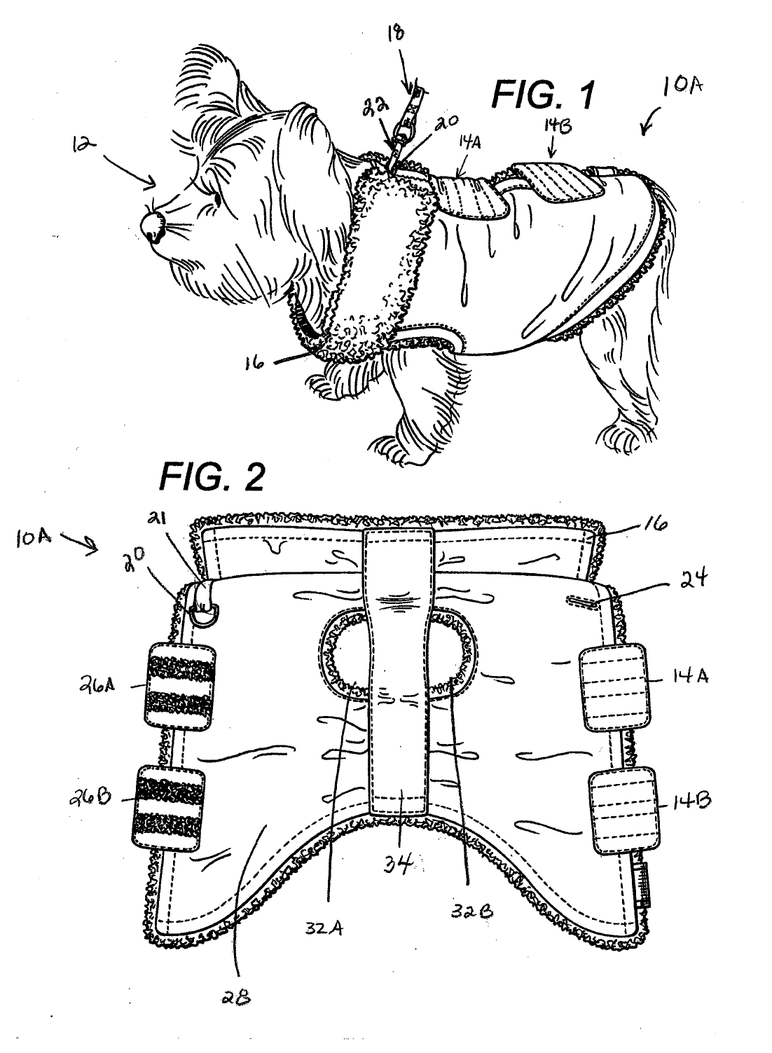

Referring now to FIG. 1, there is shown an embodiment of the pet garment of the present invention, generally designated with the reference numeral 10A. The pet garment is in the form of a wrap device or wrap 10A and is worn on the body of a wearer, namely a pet such as a dog 12. It is understood that the pet garment can be used with other types of pet animals. The wrap 10A generally extends around the body of the dog 12, typically the torso of the dog 12. In one exemplary embodiment, the wrap 10A encircles the body of the dog 12. The wrap 10A includes first tabs 14A,14B on a first side and also includes second tabs 26A,26B on a second side. The tabs 14A,14B,26A,26B form part of a securing assembly used to fasten the wrap 10A around the dog 12. As explained in greater detail below, the tabs include a hook and loop fastener system. The wrap 10A also has an outer side 28 facing away from the dog 12 and an inner side 30 that is immediately adjacent the dog 12 when the pet garment is secured to the dog 12. The wrap 10A contains a collar portion 16. As shown in FIGS. 1 and 2, the collar 16 may be extended and worn by the dog 12 in the extended position. As further shown in FIGS. 1 and 2, the wrap 10A includes a leash fastening assembly. When the wrap 10A is wrapped around dog 12, a ring 20, which is attached to wrap 10A, can be inserted through a slit opening 24 permitting a leash connector 22 to engage ring 20. As shown in FIG. 2, the ring 20 is preferably located near the perimeter of wrap 10A, and corresponding slit opening 24 is located on the opposing side of the wrap 10A near the perimeter.

FIG. 2 shows the bottom view of the outer side 28 of wrap 10A. The top sides of tabs 26A, 26B are located on the outer side 28 of the wrap 10A and contain “hooks” or “loops” such as those found in Velcro® loop and hook fasteners. The wrap 10A contains two openings, a first opening 32A and a second opening 32B. The first opening 32A and the second opening 32B are configured to receive the respective front legs of the dog 12. It is understood that the openings can be sized and spaced accordingly to accommodate dogs of various sizes. The wrap 10A contains a middle portion 34, or middle section 34 that is located between a first opening 32A and a second opening 32B. The middle section 34 can also vary in length and width.

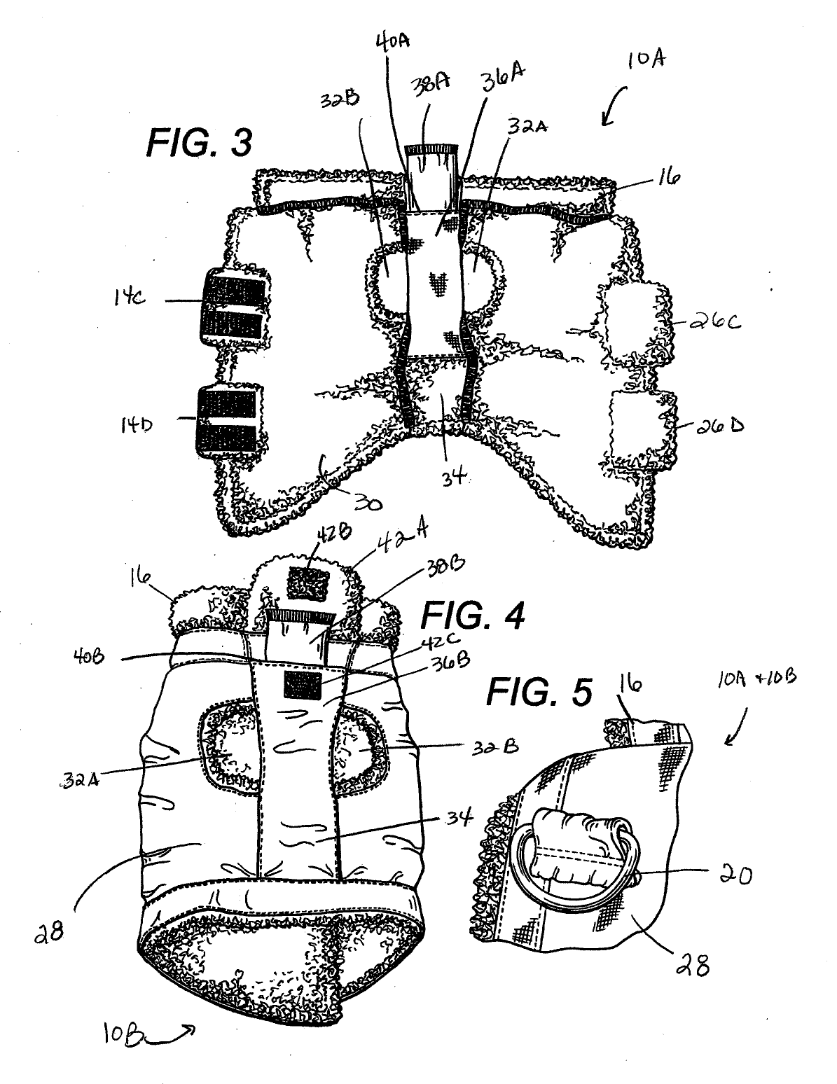

FIG. 3 shows the inner side 30 of wrap 10A which can be lined with or made of plush material as shown in FIGS. 1-5. As also shown in FIG. 3, the undersides of tabs 14C, 14D contain “hooks” or “loops” as referenced above such that the undersides of tabs 14C, 14D engage with the hooks or loops contained on the top sides of tabs 26A, 26B, which assist in securing the wrap 10A on the wearer's body.

As further shown in FIGS. 2-3, a receptacle 36A is located on or otherwise incorporated in the middle portion 34 of the inner side 30 of wrap 10A. The receptacle 36A is dimensioned to receive a treatment element as explained in greater detail below. However, it is understood that the wrap 10A in an alternative design, can have a receptacle 36B such as shown in a wrap 10B in FIG. 4. In this configuration, the receptacle 36B may be located on the middle portion of the outer side 28 of the wrap device 10B. As shown in FIGS. 3-4, receptacles 36A and 36B have receptacle openings 40A,40B that are configured to receive treatment elements 38A, 38B. Receptacles 36A and 36B are of a size to accommodate the treatment elements 38A, 38B. Treatment elements 38A,38B may be completely inserted into the receptacles 36A,36B such that no portion of the treatment elements 38A,38B extend beyond receptacle openings 40A,40B. Alternatively, the treatment elements 38A,38B may be secured in the receptacles 36A,36B by a flap 42A shown in FIG. 4, containing a closure device such as a hook and loop system 42B that engages with a corresponding surface 42C located on the receptacle 36A,B. Treatment elements 38A,38B may be a thermal gel pack (including a heat pack or cold pack), or some other device that is able to be treated such that it may be warm or cool to the touch or emit various vapors. When the treatment element is treated and inserted into the receptacle 36A,36B, it may emit heat or cold such that the wearer of the wrap feels warmth or is cooled, or it may emit various vapors to aid in treatment of the wearer. It is further understood that the middle section 34 or middle portion 34 can include apertures or be made from materials that will enhance heat transfer from the treatment elements 38A,38B to the pet 12.

As discussed, the pet garment may include a leash fastening assembly wherein a leash may be attached thereto. FIG. 5 shows a close up view of the ring 20, and its location being secured to the wrap 10A,10B. The ring 20 can be attached to the wrap via an elongated strap 21 such as shown in FIG. 2, or more closely to the wrap as shown in FIG. 5.

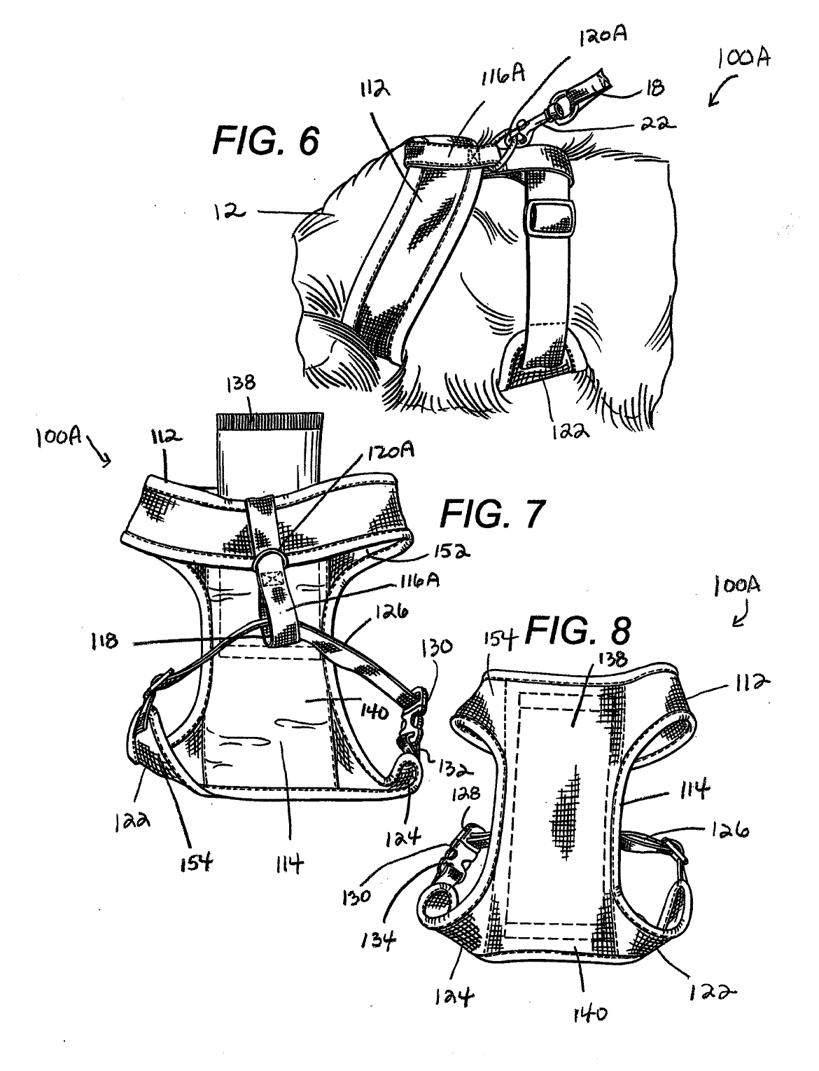

FIGS. 6-10 show additional embodiments of the wrap of the present invention and designated with the reference numerals 100A and 100B. Wraps 100A,100B, like wrap 10A,10B, and 100C, may be made out of fabrics, mesh, or other textiles, leather, or other flexible materials. Wraps 100A,100B have a band 112 which is adjacent to middle section 114. The band 112 and the middle section 114 cooperatively form an opening through which the head and neck portion of the pet wearer are inserted when wearing the wrap 100A,100B.

FIGS. 6-7 show wrap 100A having an extension member 116A. The extension member 116A extends away from the band 112 toward the end of the middle section 114 that is furthest from the band 112. One end of the extension 116A may encircle band 112 or be attached to band 112 in some other manner. The other end of the extension member 116A has a loop 118. The wrap 100A may include a leash fastening assembly. A ring 120A is affixed to extension 116A near the band 112. A leash 18 is attached to leash connector 22 which may be attached to ring 120A.

As shown in FIGS. 6-10, wraps 100A,100B have lobes 122 and 124 that are adjacent to the middle section 114 and extend from a distal end of the middle section 114. The receptacle 140 is attached to the inner side of wrap 100A,100B. The receptacle 140 may extend the length of the wrap 100A,100B but may also be shorter than the length of wrap 100A.100B. Attached to lobe 122 is strap 126 which may be adjustable in length in order to accommodate different girths of the wearer or its appendages or body parts. One end of strap 126 is attached to lobe 122. The other end of strap 126 has a flexible insert member 128, which together with a receiver 134 to be described, form part of a fastening device 130. A second strap 132 is attached to the lobe 124 and may be adjustable in length. One end of second strap 132 is attached to lobe 124 and the other end of the second strap 132 has the receiver 134. It is understood that the flexible insert member 128 and the receiver 134 cooperatively define the fastening device 130 allowing the strap 126 to be selectively attached to the lobe 124. It is noted that strap 126 could have the receiver 134, and the second strap 132 could have the flexible insert 128 to form the fastening device 130.

FIG. 7 is shows the wrap 100A in the assembled position, showing strap 126 being inserted through loop 118 to connect to the receiver 134 on second strap 132 to the flexible insert member 128 to form the fastening device 130. The middle section 114 has the receptacle 140 to receive treatment element 138. From FIGS. 7 and 8, it is understood that the treatment element 138 is received in the receptacle 140 and being shown in phantom lines where appropriate.

FIG. 8 is a bottom view of the wrap 100A in the assembled position. Again, the phantom lines in FIGS. 7 and 8 indicate the placement of treatment element 138 in receptacle 140. The receptacle 140 is located on middle section 114 and may be situated either on the inside surface 152 or outside surface 154 of the middle section 114, or both. The receptacle 140 may have a hook and loop closure represented in phantom as reference numeral 142 in FIG. 10, to retain the treatment element 138 in receptacle 140.

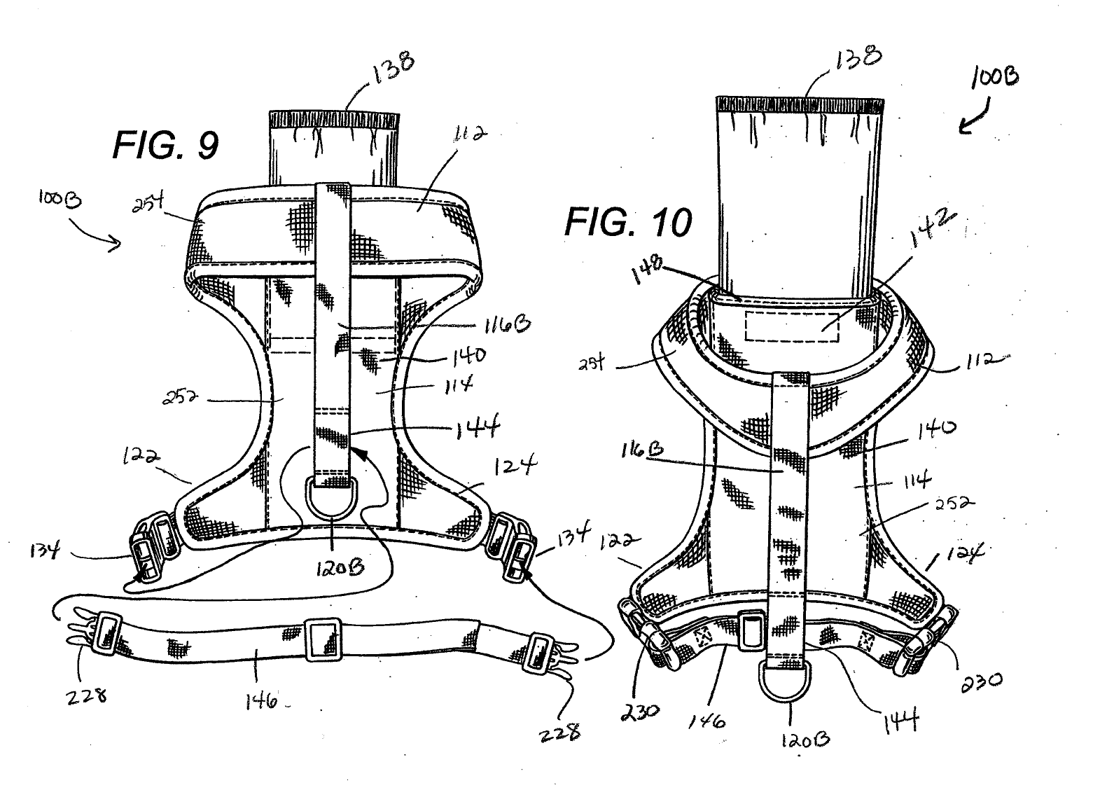

FIGS. 9 and 10 are top views of the wrap 100B, another embodiment of the wrap of the present invention. In this embodiment, the extension member 116B extends away from band 112 toward the end of middle section 114 that is furthest from band 112. One end of extension 116B may encircle band 112 or be attached to band 112 in some other manner. The other end of extension 116B engages a ring 120B. Adjacent to ring 120B is opening 144. Opening 144 receives strap 146 such that strap 146 extends through opening 144 as shown in FIG. 10. A leash connector may be attached to ring 120B consistent with the description above.

Strap 146 may be adjustable in length and has flexible inserts 228 on each end. Lobes 122 and 124 in FIGS. 9 and 10 are connected to receivers 134 which receive the flexible inserts 228 to form fastening devices 230. Alternatively, strap 146 may have receivers on each end and lobes 122 and 124 may be connected to flexible inserts to form fastening devices 230. It is noted that the fastening devices shown are the flexible insert and receiver type, but other fastening devices known in the art may also be utilized.

FIGS. 9 and 10 also show treatment element 138 partially inserted into the receptacle 140. Receptacle 140 is located on middle section 114 and may be located either on the inside surface 252 or outside surface 254 of the middle section 114, or both. The receptacle 140 may have a hook and loop closure represented in phantom as 142 to retain the treatment element 138 in receptacle 140. It is understood that the bottom side of the wrap 100B is similar to the bottom side of the wrap shown in FIG. 8. As further shown in FIG. 10, the middle section 114 of wraps 100A,100B, has a receptacle opening 148 for receiving the treatment element 138.

To place wraps 100A, 100B on the dog 12, band 112 is placed over the head of dog 12 so that the head portion of dog 12 extends through band 112 as shown in FIG. 6, and the middle section 114 is adjacent to the underside of the dog 12 such that the receptacle 140 is relatively adjacent to the thoracic and abdominal area of dog 12 (also applicable to the wraps described above). The left front leg of dog 12 is placed between band 112 and lobe 122 and the right front leg of dog 12 is placed between band 112 and lobe 124. When using wrap 100A, the end of strap 126 having the flexible insert 128 is placed through loop 118 and inserted into the receiver 134 on second strap 132 (FIGS. 7-8). A leash connector may be attached to ring 120A. When using wrap 100B, one of the ends of strap 146 having a flexible insert 228 is placed through opening 144 and inserted into a receiver 134. The remaining unconnected flexible insert 228 of strap 146 is inserted into the remaining unconnected receiver 134. A leash connector may be attached to ring 120B.

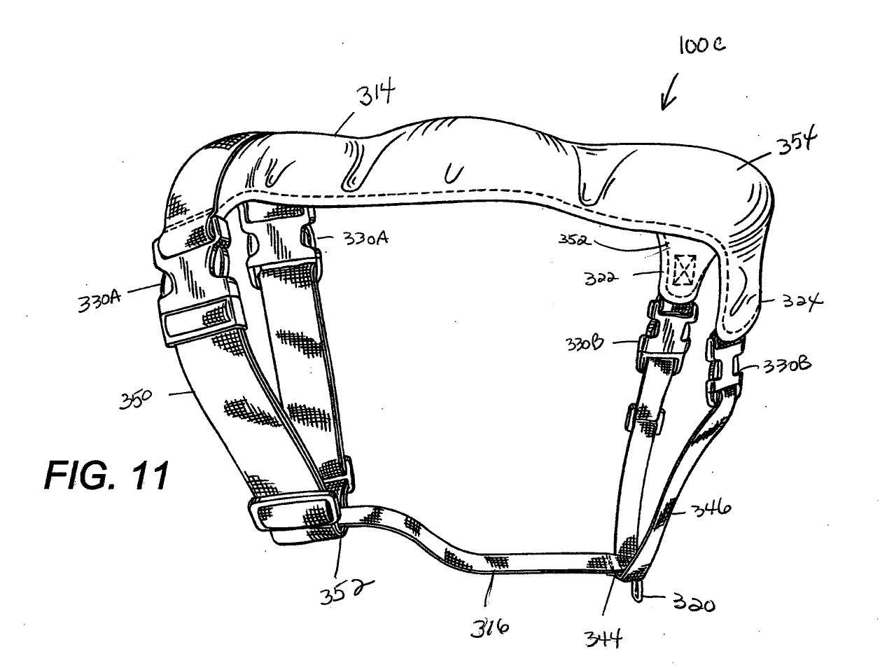

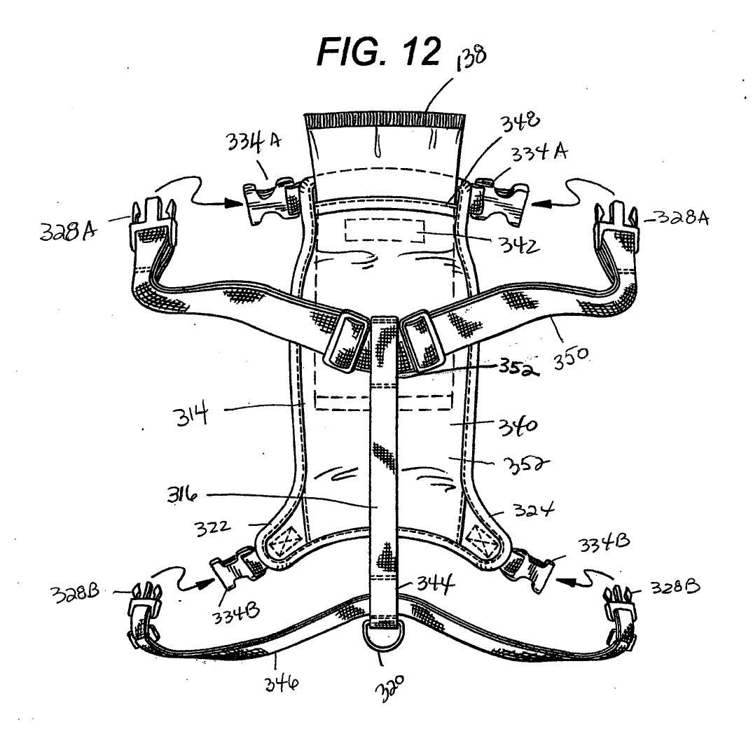

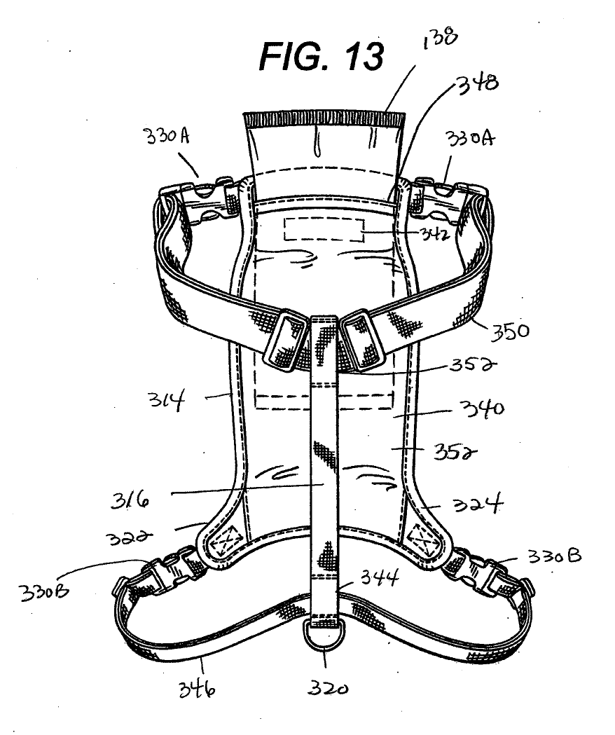

FIG. 11 is a perspective view of a wrap of the present invention, designated with the reference numeral 100C. The wrap 100C is shown in an inverted assembled position in FIG. 11. FIG. 13 is a top view of the embodiment shown in FIG. 11, and FIG. 12 is a top plan view of the embodiment shown in FIG. 11 in an unassembled position. The wrap 110C of this embodiment has a collar strap 350 which may be adjustable in length. The collar strap 350 has flexible inserts 328A on each end. Flexible inserts 328A connect to receivers 334A which receive flexible inserts 328A to form fastening devices 330A. Wrap 100C, may be made out of fabrics, mesh, or other textiles, leather, or other flexible materials.

Receivers 334A are adjacent to a first end of the middle section 314. When the flexible inserts 328A of collar strap 350 are connected to receivers 334A to form fastening devices 330A, collar strap 350 and middle section 314 form an opening through which the head and neck portion of the pet wearer are inserted when wearing the wrap 100C.

FIGS. 11-13 show wrap 100C having an extension member 316. Extension 316 extends away from collar strap 350 toward the end of middle section 314 that is furthest from collar strap 350. One end of extension 316 may encircle collar strap 350 or be attached to collar strap 350 in some other manner. The other end of extension 316 engages a ring 320.

A leash connector may be attached to ring 320 consistent with the description above. Adjacent to ring 320 is opening 344. Opening 344 receives strap 346 such that strap 346 extends through opening 344 as shown in FIGS. 11-13. Strap 346 may be adjustable in length and has flexible inserts 328B on each end.

As shown in FIGS. 11-13, wrap 100C has lobes 322 and 324 that are adjacent to and extend from the middle section 314. Lobes 322 and 324 are connected to receivers 334B which receive flexible inserts 328B to form fastening devices 330B. Alternatively, strap 346 may have receivers on each end and lobes 322 and 324 may be connected to flexible inserts to form fastening devices 330B.

FIGS. 12 and 13 also show treatment element 138 partially inserted into receptacle 340. Receptacle 340 is located on middle section 314 and may be located either on the inside surface 352 or outside surface 354 of the middle section 314, or both. The receptacle 340 may have a hook and loop closure represented in phantom as 342, to retain the treatment element 138 in receptacle 340. As shown in FIGS. 12 and 13, the middle section 314 of wrap 100C, has a receptacle opening 348 for receiving the treatment element 138.

To place wrap 100C on dog 12, one of the ends of collar strap 350 having a flexible insert 328A is placed through opening 352 and inserted into the receiver 334A. The remaining unconnected flexible insert 328A of collar strap 350 is inserted into the remaining unconnected receiver 334A. Collar strap 350 is placed over the head of dog 12 so that the head portion of dog 12 extends through collar strap 350 as shown in FIG. 6, and the middle section 314 is adjacent to the underside of the dog 12 such that the receptacle 340 is relatively adjacent to the thoracic and abdominal area of dog 12. The left front leg of dog 12 is placed between collar strap 350 and lobe 322 and the right front leg of dog 12 is placed between collar strap 350 and lobe 324. One of the ends of strap 346 having a flexible insert 328B is placed through opening 344 and inserted into the receiver 334B. The remaining unconnected flexible insert 328B of strap 346 is inserted into the remaining unconnected receiver 334B. In one embodiment of the invention, collar strap 350 is wider than strap 346 to provide a more secure and more comfortable fit of the device for larger sized pets. A leash connector may be attached to ring 320.

The pet garment of the present invention provides several benefits. The garment has a mechanism in the form of the receptacle and treatment element to provide additional heating or cooling to a pet. Such feature also provides additional therapeutic remedies for the pet depending on the type of treatment element selected. In addition, the pet garment has an integral leach fastening assembly to connect to a pet leash. Accordingly, a separately pet collar is unnecessary.

What is claimed is:

1. A pet garment worn by a pet, the pet garment comprising:
a wrap being configured to extend around a portion of the body of the pet, the wrap having a receptacle for receiving a treatment device; and
a means for securing the pet garment on the pet; and
a leash fastening assembly attached to the wrap.

2. The pet garment of claim 1 wherein the leash-fastening assembly comprises a ring attached to an outer side of the wrap.

3. The pet garment of claim 1 wherein the receptacle is located such that it is in close proximity to the thoracic or upper abdominal area of the pet.

4. The pet garment of claim 1 wherein the receptacle is located at a middle portion of the wrap.

5. The pet garment of claim 1 wherein the receptacle has a flap member adjacent an opening into the receptacle, the flap member and receptacle cooperatively having a hook and loop fastener that provides a closure for the receptacle.

6. The pet garment of claim 1 wherein the wrap has an outer side, the receptacle located on the outer side of the wrap.

7. The pet garment of claim 1 wherein the wrap has an inner side, the receptacle located on the inner side of the wrap.

8. The pet garment of claim 1 further comprising a treatment element received in the receptacle, the treatment element being one of a heat pack, a cold pack and a pack containing a vapor-emitting composition.

9. The pet garment of claim 1 wherein the wrap has a first opening and a second opening configured to receive a first leg and a second leg of the pet respectively.

10. The pet garment of claim 1 having a first tab on one side of the wrap and a second tab on another side of the wrap, the means for securing the pet garment operably associated with the pair of tabs.

11. The pet garment of claim 10 wherein the means for securing comprises a hook and loop fastener wherein a hook is located on the first tab and a loop is located on the second tab.

12. The pet garment of claim 2 wherein the wrap has a slit opening wherein the ring is received through the slit opening when the wrap is secured to the pet, the ring being configured to be attached to a leash.

13. A pet garment worn by a dog, the pet garment comprising:
a wrap having a first side and a second side and a middle portion therebetween, the wrap having a first opening proximate the middle section configured to receive a first front leg of the dog, the wrap having a second opening proximate the middle section configured to receive a second front leg of the dog, the wrap having an outer side and an inner side, the inner side having a receptacle at the middle section, the wrap configured to encircle a portion of the body of the dog;
a securing assembly connected to the wrap that secures the garment on the dog, the assembly having a first tab on the first side of the wrap and a second tab on the second side of the wrap, the securing assembly having a hook and loop fastener wherein a hook is located on one of the first tab and the second tab and a loop is located on the other of the first tab and the second tab; and
a treatment element received in the receptacle.

14. The pet garment of claim 13 further comprising a leash-fastening assembly attached to the wrap and configured to be attached to a leash.

15. The pet garment of claim 13, wherein the leash-fastening assembly comprises a ring attached to the outer side of the wrap, the wrap further having a slit opening wherein the slit opening receives the wring when the garment is placed around the dog.

16. The pet garment of claim 13 wherein the treatment element is one of a heat pack, a cold pack and a pack containing a vapor-emitting composition.

17. The pet garment of claim 16 wherein the receptacle is located in the middle section such that the treatment device is in close proximity to the thoracic or upper abdominal area of the dog.

18. A pet garment comprising:
a wrap having a middle section said middle section being on the underside of the wearer when in use;
said middle section having a receptacle for receiving a treatment device, said receptacle being located such that it is in close proximity to the thoracic or upper abdominal area of the wearer;
a band configured to accommodate the head of the wearer and encircling the neck of the wearer when in use, said band being proximate to one end of said middle section;
a strap that is located proximate to the other end of said middle section said strap being attachable to one side of the middle section and extendable across the back of the wearer and being attachable to the other side of the middle section;
an extension having a first end adjacent to said band and a second end having an opening, said opening receiving said strap; and
a leash-fastening assembly located on said extension between said first end and said opening.

19. A pet garment comprising:
a wrap having a middle section said middle section being on the underside of the wearer when in use and having a receptacle for receiving a treatment device;
said middle section having a receptacle for receiving a treatment device, said receptacle being located such that it is in close proximity to the thoracic or upper abdominal area of the wearer;
a band continuous with said middle section and configured to accommodate the head of the wearer and encircling the neck of the wearer when in use said band being proximate to one end of said middle section;
a strap that is located proximate to the other end of said middle section said strap being attachable to one side of the middle section and extendable across the back of the wearer and being attachable to the other side of the middle section;
an extension having a first end adjacent to said band and a second end having an opening proximate to the second end, said opening receiving said strap; and
said extension having a leash-fastening assembly at its second end.

20. A pet garment comprising:
a wrap having a middle section said middle section being on the underside of the wearer when in use and having a receptacle for receiving a treatment device;
said middle section having a receptacle for receiving a treatment device, said receptacle being located such that it is in close proximity to the thoracic or upper abdominal area of the wearer;
a collar strap attachable to said middle section and configured to accommodate the head of the wearer and encircling the neck of the wearer when in use said collar strap being attachable proximate to one end of said middle section;
a strap that is located proximate to the other end of said middle section said strap being attachable to one side of the middle section and extendable across the back of the wearer and being attachable to the other side of the middle section;
an extension having a first end adjacent to said collar strap and a second end having an opening proximate to the second end, said opening receiving said strap; and
said extension having a leash-fastening assembly at its second end.
